(19) United States
(12) Patent Application Publication
(10) Pub. No.: US 2025/0226913 A1
(43) Pub. Date: Jul. 10, 2025

(54) Enhancements For CQI Reporting In Mobile Communications

(71) Applicant: MediaTek Singapore Pte. Ltd., Singapore (SG)

(72) Inventors: Mohammed S Aleabe Al-Imari, Cambridge (GB); Waseem Hazim Ozan Ozan, Cambridge (GB)

(21) Appl. No.: 19/094,908

(22) Filed: Mar. 30, 2025

Related U.S. Application Data
(63) Continuation of application No. 17/481,281, filed on Sep. 21, 2021, now abandoned.
(60) Provisional application No. 63/104,635, filed on Oct. 23, 2020.

(51) Int. Cl. H04L 1/00

(52) U.S. Cl. CPC H04L 1/0026; H04L 1/0003; H04L 1/0007

(57) ABSTRACT

Various solutions pertaining to enhancements for channel quality indicator (CQI) reporting in mobile communications are described. An apparatus implemented in a user equipment (UE) generates a CQI report using a transport block (TB) size. The apparatus then transmit the CQI report to a network. The TB size is either configured by the network or calculated by the apparatus. In case the TB size is calculated, the apparatus calculates the TB size using either a scaling factor or one or more values related to reference radio resources.

### CROSS REFERENCE TO RELATED PATENT APPLICATION(S)

The present disclosure is a Continuation of U.S. patent application Ser. No. 17/481,281, filed 21 Sep. 2021 and claiming the priority benefit of U.S. Patent Application No. 63/104,635, filed on 23 Oct. 2020. Contents of the aforementioned applications are herein incorporated by reference in their entirety.

### TECHNICAL FIELD

The present disclosure is generally related to mobile communications and, more particularly, to enhanced channel quality indicator (CQI) reporting in mobile communications.

### BACKGROUND

Unless otherwise indicated herein, approaches described in this section are not prior art to the claims listed below and are not admitted as prior art by inclusion in this section.

In mobile communications, such as 5^{th} Generation (5G) New Radio (NR) based on the 3^{rd} Generation Partnership Project (3GPP) specifications, the ‘cqi-table’ field in the radio resource control (RRC) information element (IE) indicates to a user equipment (UE) which CQI table should be used for CQI reporting sent to a network. Specifically, there are three tables which are 64QAM table, 256QAM table and low-spectral efficiency table. Two transport block error probability are defined for the three tables, namely 0.1 and 0.00001. For CQI reporting, the channel state information (CSI) reference resource assumptions are used. The transport block size (TBS) that is used for CQI calculation is based on downlink (DL) physical resource blocks (PRBs) defined for the CSI reference resource. However, the TB size for the actual transmission by a base station (e.g., gNB) could be significantly different from the one assumed by the UE for CQI calculation. Thus, this could impact the modulation coding scheme (MCS) selection at the base station since, for example, the signal to noise or interference ratio (SINR) values for the reported CQI could not be accurately estimated at the base station.

In order for the base station to assign a corresponding MCS for the reported CQI values, the base station knows which CQI table is used for the CQI reporting, hence the reported CQI values can be mapped directly into an MCS value. Nevertheless, the CQI reporting does not take into account the effects of TB SIZE on the probability of errors. The CQI reporting may always be based on a fixed TB SIZE and may have a different TB SIZE at the base station, meaning the reporting CQI values may not be accurately valid. For example, assuming that the UE is using a reference TBS=32 bytes for reporting CQI values and the CQI value received by the base station=10 while the base station intends to send DL data with TBS=200 bytes, the base station does not know the SINR-to-MCS mapping for the 200-byte TBS and the base station also needs to determine a method to map the difference in CQI values. On the other hand, the UE can generate the SINR-to-CQI/MCS mapping for different TB sizes, however, only the reported CQI is based on a single TBS. Therefore, there is a need for a solution of enhancements for CQI reporting in mobile communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to enhancements for CQI reporting in mobile communications. It is believed that various schemes proposed herein may address or otherwise mitigate the issues described above.

In one aspect, a method may involve generating a CQI report using a TB size configured by a network. The method may also involve transmitting the CQI report to the network.

In another aspect, a method may involve calculating a TB size. The method may also involve generating a CQI report using the calculated TB size. The method may further involve transmitting the CQI report to the network.

In yet another aspect, an apparatus may comprise a transceiver which, during operation, wirelessly communicates with a network node of a wireless network. The apparatus may also comprise a processor communicatively coupled to the transceiver. The processor, during operation, may generate a CQI report using a TB size and then transmit, via the transceiver, the CQI report to the wireless network. The TB size may be configured by the wireless network. Alternatively, the TB size may be calculated by the processor using either a scaling factor or one or more values related to reference radio resources.

It is noteworthy that, although description provided herein may be in the context of certain radio access technologies, networks and network topologies such as 5G/NR, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, Internet-of-Things (IoT), Industrial Internet-of-Things (IIoT) and Narrow Band Internet of Things (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of out-of-order HARQ restriction in accordance with implementations of the present disclosure.

FIG. 2 is a block diagram of an example communication apparatus and an example network apparatus in accordance with an implementation of the present disclosure.

FIG. 3 is a flowchart of an example process in accordance with an implementation of the present disclosure.

FIG. 4 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to enhancements for CQI reporting in mobile communications. According to the present disclosure, a number of possible solutions may be implemented separately or jointly. That is, although these possible solutions may be described below separately, two or more of these possible solutions may be implemented in one combination or another.

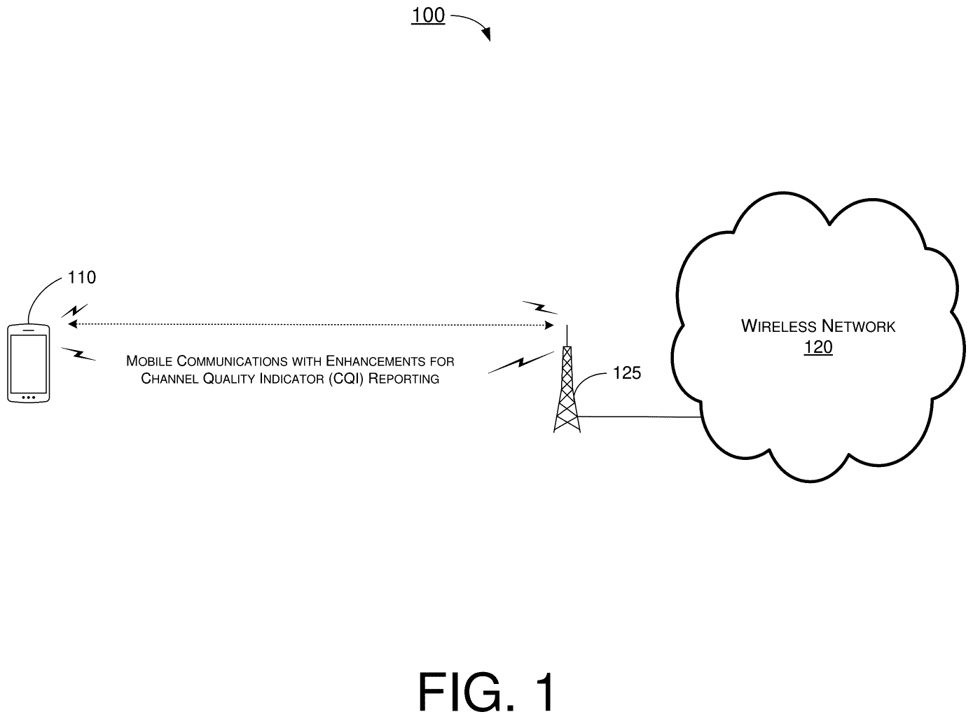

FIG. 1 illustrates an example network environment 100 in which various solutions and schemes in accordance with the present disclosure may be implemented. Referring to FIG. 1, network environment 100 may involve a UE 110 in wireless communication with a wireless network 120 (e.g., a 5G NR mobile network or another type of network such as a non-terrestrial network (NTN)). UE 110 may be in wireless communication with wireless network 120 via a base station or network node 125 (e.g., an eNB, gNB, transmit-receive point (TRP) or satellite). In network environment 100, UE 110 and wireless network 120 may implement various schemes pertaining to enhancements for CQI reporting in mobile communications, as described below.

Under a first proposed scheme in accordance with the present disclosure, to enhance CQI reporting, network node 125 may configure UE 110 with one or more TB sizes that UE 110 may use for CQI reporting. That is, UE 110 may receive from network node 125 a configuration signaling that configures one or more TB sizes which UE 110 may use in generating a CQI report for transmission to network node 125.

Under a second proposed scheme in accordance with the present disclosure, UE 110 may be configured with one or more values for reference radio resources that may be used in calculating the TB size for CQI reporting. For instance, UE 110 may be configured by network node 125 with a number of orthogonal frequency-division multiplexing (OFDM) symbols and/or PRBs that may be used in calculating the TB size for CQI reporting.

Under a third proposed scheme in accordance with the present disclosure, UE 110 may be configured with a scaling factor that may be used in calculating the TB size for CQI reporting. Under the proposed scheme, UE 110 may use one or more CSI reference resource assumptions (e.g., with an existing mechanism defined in Release 15 (R15)/Release 16 (R16) of the 3GPP specification for 5G/NR) and may be configured with a scaling factor, which may be a value less than or equal to 1, to calculate the TB size for CQI reporting. For instance, UE 110 may be configured by network node 125 with a scaling factor X (e.g., X=0.7), and the TB size used for CQI reporting may be 0.7×the TB size based on the existing mechanism defined in R15 and/or R16 of the 3GPP specification.

In implementing each, some or all of the first, second and third proposed schemes, UE 110 may be further configured with or otherwise may further implement one or more of the features described below.

In one implementation, the TB size may be configured or applied per CQI report (e.g., in the RRC IE parameter for CSI report configuration, CSI-ReportConfig). In another implementation, UE 110 may be configured with different TB sizes for different CQI reports. In yet another implementation, for the CQI reports that are not configured with TB sizes for CQI calculation, UE 110 may use the TB size based on the CSI reference resource (e.g., the existing mechanism in NR R15/R16).

In one implementation, the TB size for CQI reporting may be configured according to a CQI table. For instance, the TB size for CQI Table 3 may be equal to 32 byes, and the TB size for CQI Table 1 may be equal to 200 bytes. In another implementation, the TB size for CQI reporting may be changed or configured based on the configured bandwidth part (BWP) size. In another implementation, the TB size for CQI reporting may be changed or configured based on the number of subbands for CQI reporting. In another implementation, the TB size for CQI reporting may be changed or configured according to the size of subbands. In another implementation, the TB size for CQI reporting may be changed or configured based on report configuration type (e.g., periodic, semi-periodic on physical uplink control channel (PUCCH) or physical uplink shared channel (PUSCH)) or per triggering mechanism. For instance, the TB size may be equal to 32 bytes for a periodic CSI or 200 bytes for an aperiodic CSI.

In one implementation, the TB size for CQI reporting may be changed or configured according to a rank indicator (RI), multiple-input-multiple-output (MIMO) layers, port index, precoding matrix indicator (PMI) and/or code type. In another implementation, the TB size for CQI reporting may be changed or configured according to the numerology (e.g., bandwidth subcarrier spacing). In another implementation, the TB size for CQI reporting may be changed or configured based on the CQI format indicator (e.g., in the RRC IE parameter for CSI report configuration, CSI-ReportConfig). For instance, different TB sizes may be configured for the calculation of the wideband (WB)-CQI and subband (SB)-CQIs.

In one implementation, the TB size for CQI reporting may be changed or configured according to the serving cell. In another implementation, the TB size for CQI reporting may be changed or configured according to the report quantity. For instance, the TB size may be X number of bytes for ‘cri-RI-CQ’. In another implementation, the TB size for CQI reporting may be configured based on the periodicity of CSI reporting. For instance, in case the periodicity is equal to 4 slots, the TB size may be equal to 32 bytes. Alternatively, in case the periodicity is equal to 8 slots, the TB size may be equal to 200 bytes. In another implementation, the TB size for CQI reporting may be configured based on a CSI reporting timing offset list. For instance, in case the configured offset is equal to 5 slots, the TB size may be equal to 32 bytes. Alternatively, in case the configured offset is equal to 10 slots, the TB size may be equal to 100 bytes. Otherwise, the TB size may be equal to 200 bytes. In another implementation, the TB size for CQI reporting may be configured based on a timing offset list and CSI reporting periodicity.

It is noteworthy that the TB size for CQI reporting may be changed or configured according to various combinations of some or all of the features described above. It is also noteworthy that, additional information may be reported under various proposed schemes, as described below.

Under a fourth proposed scheme in accordance with the present disclosure, UE 110 may report a MCS offset and/or a CQI offset between two MCS curves and/or between two CQI curves generated for two TB sizes.

Under a fifth proposed scheme in accordance with the present disclosure, UE 110 may report a theta angle (θ) offset between two MCS curves and/or between two CQI curves generated for two TB sizes.

Under a fourth proposed scheme in accordance with the present disclosure, UE 110 may report a MCS offset and/or a CQI offset between two MCS curves and/or between two CQI curves as well as a theta angle (θ) offset between two MCS curves and/or between two CQI curves generated for two TB sizes.

It is noteworthy that each of the proposed schemes described herein may be implemented individually as well as jointly. That is, in some cases, each of the above-described proposed schemes may be implemented individually by UE 110 to achieve enhancements for CQI reporting to wireless network 120. In other cases, some or all of the above-described proposed schemes may be implemented jointly by UE 110 to achieve enhancements for CQI reporting to wireless network 120.

### Illustrative Implementations

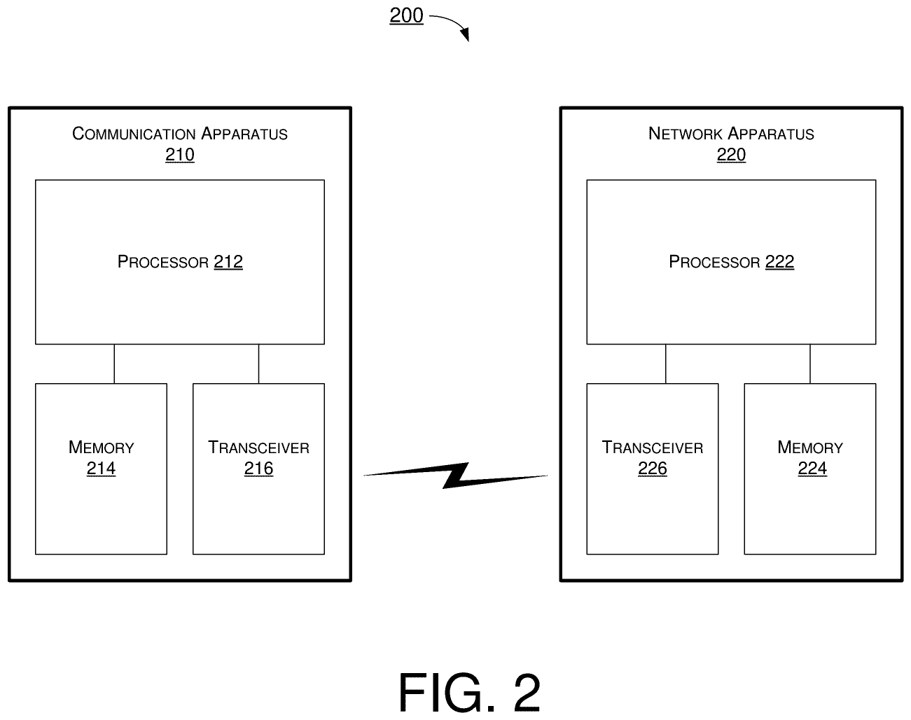

FIG. 2 illustrates an example communication apparatus 210 and an example network apparatus 220 in accordance with an implementation of the present disclosure. Each of communication apparatus 210 and network apparatus 220 may perform various functions to implement schemes, techniques, processes and methods described herein pertaining to CQI reporting in mobile communications, including scenarios/schemes described above as well as the process(es) described below.

Communication apparatus 210 may be a part of an electronic apparatus, which may be a UE such as a portable or mobile apparatus, a wearable apparatus, a wireless communication apparatus or a computing apparatus. For instance, communication apparatus 210 may be implemented in a smartphone, a smartwatch, a personal digital assistant, a digital camera, or a computing equipment such as a tablet computer, a laptop computer or a notebook computer. Communication apparatus 210 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 210 may be implemented in a smart thermostat, a smart fridge, a smart door lock, a wireless speaker or a home control center. Alternatively, communication apparatus 210 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 210 may include at least some of those components shown in FIG. 2 such as a processor 212, for example. Communication apparatus 210 may further include one or more other components not pertinent to the proposed scheme of the present disclosure (e.g., internal power supply, display device and/or user interface device), and, thus, such component(s) of communication apparatus 210 are neither shown in FIG. 2 nor described below in the interest of simplicity and brevity.

Network apparatus 220 may be a part of an electronic apparatus, which may be a network node such as a base station, a small cell, a router or a gateway. For instance, network apparatus 220 may be implemented in an eNodeB in an LTE, LTE-Advanced or LTE-Advanced Pro network or in a gNB in a 5G, NR, IoT, NB-IoT or IIoT network. Alternatively, network apparatus 220 may be implemented in the form of one or more IC chips such as, for example and without limitation, one or more single-core processors, one or more multi-core processors, or one or more RISC or CISC processors. Network apparatus 220 may include at least some of those components shown in FIG. 2 such as a processor 222, for example. Network apparatus 220 may further include one or more other components not pertinent to the proposed scheme of the present disclosure (e.g., internal power supply, display device and/or user interface device), and, thus, such component(s) of network apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged and configured to perform specific tasks including enhancements for CQI reporting in mobile communications in accordance with various implementations of the present disclosure.

In some implementations, communication apparatus 210 may also include a transceiver 216 coupled to processor 212 and capable of wirelessly transmitting and receiving data. In some implementations, communication apparatus 210 may further include a memory 214 coupled to processor 212 and capable of being accessed by processor 212 and storing data therein. In some implementations, network apparatus 220 may also include a transceiver 226 coupled to processor 222 and capable of wirelessly transmitting and receiving data. In some implementations, network apparatus 220 may further include a memory 224 coupled to processor 222 and capable of being accessed by processor 222 and storing data therein. Accordingly, communication apparatus 210 and network apparatus 220 may wirelessly communicate with each other via transceiver 216 and transceiver 226, respectively.

To aid better understanding, the following description of the operations, functionalities and capabilities of each of communication apparatus 210 and network apparatus 220 is provided in the context of a mobile communication environment in which communication apparatus 210 is implemented in or as a UE (e.g., UE 110) and network apparatus 220 is implemented in or as a network node of a communication network (e.g., network node 125 of wireless network 120).

Under one or more proposed schemes in accordance with the present disclosure, processor 212 of apparatus 210, implemented in or as UE 110, may generate a CQI report using a TB size configured by a network (e.g., wireless network 120). Additionally, processor 212 may transmit, via transceiver 216, the CQI report to the network (e.g., via network apparatus 220 as network node 125).

In some implementations, in generating the CQI report, processor 212 may apply the TB size for the CQI report in a RRC IE parameter CSI-ReportConfig.

In some implementations, multiple TB sizes may be configured by the network. In such cases, in generating the CQI report, processor 212 may apply different TB sizes of the multiple TB sizes in generating different CQI reports.

In some implementations, in generating the CQI report, processor 212 may generate the CQI report using the TB size based on a CSI reference resource.

In some implementations, the TB size may be configured based on a CQI format indicator.

In some implementations, in generating the CQI report, processor 212 may calculate a WB-CQI using a first TB size or calculating a SB-CQI using a second TB size different from the first TB size.

In some implementations, processor 212 may perform additional operations. For instance, processor 212 may report to the network either or both of: (a) a MCS offset between two MCS curves generated for two TB sizes, and (b) a CQI offset between two CQI curves generated for the two TB sizes.

Under one or more proposed schemes in accordance with the present disclosure, processor 212 of apparatus 210, implemented in or as UE 110, may calculate a TB size. Moreover, processor 212 may generate a CQI report using the calculated TB size. Furthermore, processor 212 may transmit, via transceiver 216, the CQI report to a network (e.g., to wireless network 120 via network apparatus 220 as network node 125).

In some implementations, in calculating the TB size, processor 212 may calculate the TB size using one or more values related to reference radio resources.

In some implementations, in calculating the TB size, processor 212 may calculate the TB size using a scaling factor. In some implementations, in calculating the TB size using the scaling factor, processor 212 may calculate the TB size by multiplying the scaling factor with a TB size which is based on a CSI reference resource.

In some implementations, in generating the CQI report, processor 212 may apply the TB size for the CQI report in a RRC IE parameter CSI-ReportConfig.

In some implementations, in calculating the TB size, processor 212 may calculate multiple TB sizes. In such cases, in generating the CQI report, processor 212 may apply different TB sizes of the multiple TB sizes in generating different CQI reports.

In some implementations, in generating the CQI report, processor 212 may generate the CQI report using the TB size based on a CSI reference resource.

In some implementations, the TB size may be configured based on a CQI format indicator.

In some implementations, in calculating the TB size, processor 212 may calculate a first TB size and a second TB size different from the first TB size. Moreover, in generating the CQI report, processor 212 may calculate a WB-CQI using the first TB size or calculate a SB-CQI using the second TB size.

In some implementations, processor 212 may perform additional operations. For instance, processor 212 may report to the network either or both of: (a) a MCS offset between two MCS curves generated for two TB sizes, and (b) a CQI offset between two CQI curves generated for the two TB sizes.

### Illustrative Processes

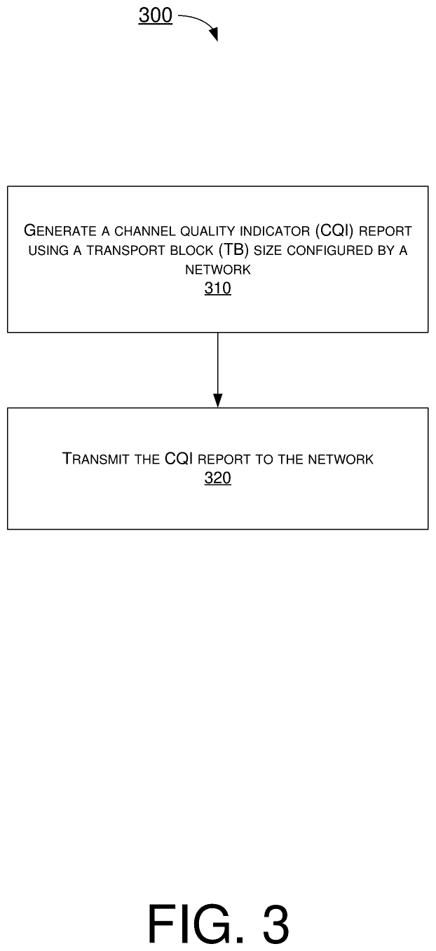

FIG. 3 illustrates an example process 300 in accordance with an implementation of the present disclosure. Process 300 may be an example implementation of schemes described above whether partially or completely, with respect to CQI reporting in mobile communications. Process 300 may represent an aspect of implementation of features of communication apparatus 210 and/or network apparatus 220. Process 300 may include one or more operations, actions, or functions as illustrated by one or more of blocks 310 and 320. Although illustrated as discrete blocks, various blocks of process 300 may be divided into additional blocks, combined into fewer blocks, or eliminated, depending on the desired implementation. Moreover, the blocks of process 300 may executed in the order shown in FIG. 3 or, alternatively, in a different order. Process 300 may be implemented by communication apparatus 210 or any suitable UE or machine type devices. Solely for illustrative purposes and without limitation, process 300 is described below in the context of communication apparatus 210 implemented in or as UE 110 in network environment 100 and network apparatus 220 implemented in or as network node 125 in network environment 100. Process 300 may begin at block 310.

At 310, process 300 may involve processor 212 of apparatus 210 generating a CQI report using a TB size configured by a network (e.g., wireless network 120). Process 300 may proceed from 310 to 320.

At 320, process 300 may involve processor 212 transmitting, via transceiver 216, the CQI report to the network (e.g., via network apparatus 220 as network node 125).

In some implementations, in generating the CQI report, process 300 may involve processor 212 applying the TB size for the CQI report in a RRC IE parameter CSI-ReportConfig.

In some implementations, multiple TB sizes may be configured by the network. In such cases, in generating the CQI report, process 300 may involve processor 212 applying different TB sizes of the multiple TB sizes in generating different CQI reports.

In some implementations, in generating the CQI report, process 300 may involve processor 212 generating the CQI report using the TB size based on a CSI reference resource.

In some implementations, the TB size may be configured based on a CQI format indicator.

In some implementations, in generating the CQI report, process 300 may involve processor 212 calculating a WB-CQI using a first TB size or calculating a SB-CQI using a second TB size different from the first TB size.

In some implementations, process 300 may involve processor 212 performing additional operations. For instance, process 300 may involve processor 212 reporting to the network either or both of: (a) a MCS offset between two MCS curves generated for two TB sizes, and (b) a CQI offset between two CQI curves generated for the two TB sizes.

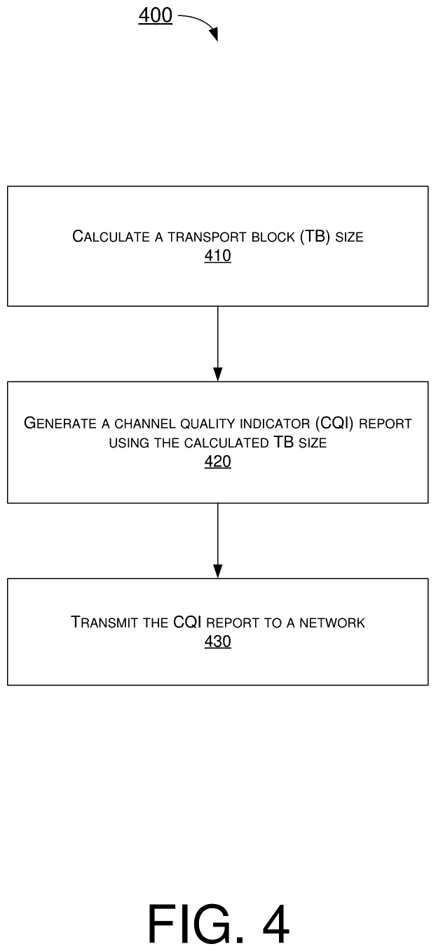

FIG. 4 illustrates an example process 400 in accordance with an implementation of the present disclosure. Process 400 may be an example implementation of schemes described above whether partially or completely, with respect to CQI reporting in mobile communications. Process 400 may represent an aspect of implementation of features of communication apparatus 210 and/or network apparatus 220. Process 400 may include one or more operations, actions, or functions as illustrated by one or more of blocks 410, 420 and 430. Although illustrated as discrete blocks, various blocks of process 400 may be divided into additional blocks, combined into fewer blocks, or eliminated, depending on the desired implementation. Moreover, the blocks of process 400 may executed in the order shown in FIG. 4 or, alternatively, in a different order. Process 400 may be implemented by communication apparatus 210 or any suitable UE or machine type devices. Solely for illustrative purposes and without limitation, process 400 is described below in the context of communication apparatus 210 implemented in or as UE 110 in network environment 100 and network apparatus 220 implemented in or as network node 125 in network environment 100. Process 400 may begin at block 410.

At 410, process 400 may involve processor 212 of apparatus 210 calculating a TB size. Process 400 may proceed from 410 to 420.

At 420, process 400 may involve processor 212 generating a CQI report using the calculated TB size. Process 400 may proceed from 420 to 430.

At 430, process 400 may involve processor 212 transmitting the CQI report to a network (e.g., to wireless network 120 via network apparatus 220 as network node 125).

In some implementations, in calculating the TB size, process 400 may involve processor 212 calculating the TB size using one or more values related to reference radio resources.

In some implementations, in calculating the TB size, process 400 may involve processor 212 calculating the TB size using a scaling factor. In some implementations, in calculating the TB size using the scaling factor, process 400 may involve processor 212 calculating the TB size by multiplying the scaling factor with a TB size which is based on a CSI reference resource.

In some implementations, in generating the CQI report, process 400 may involve processor 212 applying the TB size for the CQI report in a RRC IE parameter CSI-ReportConfig.

In some implementations, in calculating the TB size, process 400 may involve processor 212 calculating multiple TB sizes. In such cases, in generating the CQI report, process 400 may involve processor 212 applying different TB sizes of the multiple TB sizes in generating different CQI reports.

In some implementations, in generating the CQI report, process 400 may involve processor 212 generating the CQI report using the TB size based on a CSI reference resource.

In some implementations, the TB size may be configured based on a CQI format indicator.

In some implementations, in calculating the TB size, process 400 may involve processor 212 calculating a first TB size and a second TB size different from the first TB size. Moreover, in generating the CQI report, process 400 may involve processor 212 calculating a WB-CQI using the first TB size or calculating a SB-CQI using the second TB size.

In some implementations, process 400 may involve processor 212 performing additional operations. For instance, process 400 may involve processor 212 reporting to the network either or both of: (a) a MCS offset between two MCS curves generated for two TB sizes, and (b) a CQI offset between two CQI curves generated for the two TB sizes.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
generating a channel quality indicator (CQI) report using a transport block (TB) size configured by a network;
transmitting the CQI report to the network; and
reporting to the network either or both of:
a modulation coding scheme (MCS) offset between two MCSs generated for two TB sizes, and
a CQI offset between two CQIs generated for the two TB sizes,
wherein the generating of the CQI report comprises calculating a first CQI of the two CQIs using a first TB size of the two TB sizes or calculating a second CQI of the two CQIs using a second TB size of the two TB sizes different from the first TB size.

2. The method of claim 1, wherein the generating of the CQI report comprises applying the TB size for the CQI report in a radio resource control (RRC) information element (IE) parameter CSI-ReportConfig.

3. The method of claim 1, wherein multiple TB sizes are configured by the network, and wherein the generating of the CQI report comprises applying different TB sizes of the multiple TB sizes in generating different CQI reports.

4. The method of claim 1, wherein the generating of the CQI report comprises generating the CQI report using the TB size based on a channel state information (CSI) reference resource.

5. The method of claim 1, wherein the TB size is configured based on a CQI format indicator.

6. The method of claim 1, wherein:
the TB size for the CQI report is configurable based on a configured bandwidth part (BWP) size; or
the TB size for the CQI report is configurable based on a number of subbands for CQI reporting; or
the TB size for the CQI report is configurable according to a size of the subbands; or
the TB size for the CQI report is configurable based on a report configuration type or per triggering mechanism; or
the TB size is equal to 32 bytes for a periodic channel state information (CSI) or 200 bytes for an aperiodic CSI.

7. An apparatus implementable in a user equipment (UE), comprising:
a transceiver configured to wirelessly communicate with a network; and
a processor coupled to the transceiver and configured to perform operations comprising:
generating a channel quality indicator (CQI) report using a transport block (TB) size configured by a network;
transmitting, via the transceiver, the CQI report to the network; and
reporting, via the transceiver, to the network either or both of:
a modulation coding scheme (MCS) offset between two MCSs generated for two TB sizes, and
a CQI offset between two CQIs generated for the two TB sizes,
wherein the generating of the CQI report comprises calculating a first CQI of the two CQIs using a first TB size of the two TB sizes or calculating a second CQI of the two CQIs using a second TB size of the two TB sizes different from the first TB size.

8. The apparatus of claim 7, wherein the generating of the CQI report comprises applying the TB size for the CQI report in a radio resource control (RRC) information element (IE) parameter CSI-ReportConfig.

9. The apparatus of claim 7, wherein multiple TB sizes are configured by the network, and wherein the generating of the CQI report comprises applying different TB sizes of the multiple TB sizes in generating different CQI reports.

10. The apparatus of claim 7, wherein the generating of the CQI report comprises generating the CQI report using the TB size based on a channel state information (CSI) reference resource.

11. The apparatus of claim 7, wherein the TB size is configured based on a CQI format indicator.

12. The apparatus of claim 7, wherein:
the TB size for the CQI report is configurable based on a configured bandwidth part (BWP) size; or
the TB size for the CQI report is configurable based on a number of subbands for CQI reporting; or
the TB size for the CQI report is configurable according to a size of the subbands; or
the TB size for the CQI report is configurable based on a report configuration type or per triggering mechanism; or
the TB size is equal to 32 bytes for a periodic channel state information (CSI) or 200 bytes for an aperiodic CSI.
